(19) United States
(12) Patent Application Publication
(10) Pub. No.: US 2011/0230324 A1
(43) Pub. Date: Sep. 22, 2011

(54) STRUCTURE OF MULTIPURPOSE SHEET FOLDING AND STACKING MACHINE

(75) Inventor: Alessandro De Matteis, Lucca (IT)

(73) Assignee: MTC- MACCHINE TRANSFORMAZIONE CARTA S.r.L., Porcari (IT)

(21) Appl. No.: 13/119,086

(22) PCT Filed: Sep. 15, 2009
(86) PCT No.: PCT/EP2009/006655

§ 371 Date: May 24, 2011

(30) Foreign Application Priority Data
Sep. 19, 2008 (EP) 08164698.6

(51) Int. Cl. B31F 1/10

(52) U.S. Cl. 493/442

(57) ABSTRACT

Folding and stacking machine (100) of a web of paper, or similar products comprising a first sheet feeding line (201) and a second sheet feeding line (202). The machine (100) comprises, furthermore, a folding section (200) having a couple of folding rollers (7, 8) that work at a linear folding speed V_{P} and are adapted to receive a plurality of sheets (11) of length L that are overlapped for a fraction Y of their length L and to fold them into a plurality of panels (P). The first and the second sheet feeding lines (201, 202) provide respective cutting sections of the sheets starting from webs of paper (10, 10′). These proceed respectively at a speed V₁ and V₂ with respect to the folding speed V_{P}, where a first speed (V₁) has a ratio X₁ with respect to the folding speed V_{P}, V₂ and a second has speed V₂ second h a ratio X₂ with respect to the folding speed V_{P}. The first and the second sheet feeding lines (201, 202) can be operated selectively and independently, i.e. separately from each other or at the same time, according to the desired type of interfolded configuration.

### FIELD OF THE INVENTION

The present invention relates to the production of paper material in stacks of sheets, for example interfolded sheets, and, in particular, it relates to a structure of folding and stacking machine of such sheets.

### BACKGROUND OF THE INVENTION

As well known, in the paper converting industry a variety of types is used of machines and of processes for making paper tissues, paper towels and similar articles in stacks of sheets of a certain height.

In many applications the packs are obtained by stacking the sheets in an “interfolded” way, i.e. at each fold a wing of the previous sheet and a wing of a next stack sheet engage with each other. This way, when drawing a sheet from a package, at the moment of the use, also a wing of a next stack panel Is dragged up to protruding from the package, with subsequent practical employment for certain types of users. Among possible interfolding ways the L-type, with 2 panels (single fold), or the Z or W types, respectively with 3 and 4 panels (multi fold), are known.

In other applications the packs are obtained folding the sheets in a not interfolded way, by folding sheets not overlapped to one another, or sheets overlapped but holding them in such that that a panel of a previous panel Is not enclosed in a panel of a immediately successive sheet.

The folding and stacking machines use one or more webs of paper, coming from one or more reels, and that are cut into sheets and fed overlapped in a way overlapped or not overlapped on folding counter-rotating rollers.

More precisely, for example as disclosed in U.S. Pat. No. 6,228,014, the webs are cut into sheets by means of cutting rollers that interact alternatively, with relative counter-support blades. In case of L-type interfolding (single-fold) the webs are cut to form a shifted succession of sheets coming from two different directions. Then, the sheets coming from either directions are fed in an alternated way to the folding rollers, so that each sheet coming from the first direction is overlapped with a portion of the sheet coming from the second direction, and vice-versa. In general, they are overlapped about at the middle of the sheets.

The sheets coming from the two directions, in order to be folded in the way above described, adhere to the respective folding rollers by a holding system comprising either suction holes or mechanical clamps. Then, the downstream portion of each sheet leaves a respective folding roller at the contact line between the two rollers, held by the other folding roller, which is holding already the upstream portion of the previous sheet.

In case of Z or W type interfolding, or even in case of much more folds, as disclosed in U.S. Pat. No. 3,490,762, so-called “multifold”, the interfolding method can be similar to what described above, with the difference that The overlapping step between two successive sheets is carried out immediately after the cut and a stream of partially overlapped sheets reaches the folding rollers from a single direction. In particular the overlapping step is carried out by a speed difference of the sheets, which during the cut have a first speed V₁, and are transferred on an overlap roller, which travels at a second speed V₂ less than said first speed V₁, so that by raising the tail of a previous sheet the head of a next sheet slips under this tail owing to the above described speed difference.

Also qui, a suction system or a holding system with mechanical clamps causes to the flow of interfolded sheets, starting from the point of contact between the two rollers, to follow alternatively one or the other roller, creating an “accordion” that is progressively flattened creating a stack of interfolded sheets.

In particular the folding rollers have a linear speed equal to V_{P}=V₂ and a circumference equal to a multiple of twice the length of the sheet. Therefore, the stack of sheets increases two panels after each fraction of turn of the folding rollers, corresponding to two successive gripping points on a same folding roller. This parameter determines the size of the folded sheet being stacked, i.e. the width of the interfolded sheets packages. In view of that, one of the parameters of reference for a multi-fold interfolding machine is the stack width.

Another reference parameter for an interfolding machine is the length of the sheets, also called cut-off. In particular, the length of the interfolded sheets that eventually form the stack of final product is responsive to the circumference of the cutting rollers and to the angular distance among the cutting blades. In other words, the cutting length is fixed and is determined univocally by the circumference of the cutting roller or rollers.

The need is felt for the production of folded stacks of sheets, either interfolded or not, of having a flexible production, in order to make, according to the needs of the market, stacks of different width, or stacks with folded sheets into a different number of panels. In general, a folding and stacking machine is rather stiff, and provides a single panel width and a single type of product, for example L, Z, W-like interfolded types in case of interfolded products. It is not possible, in general, to change production type except from the cases described below.

By changing the width of the packages it is possible to make different interfolded products, capable of meeting the needs of different markets. In EP1630118, in the name of the same applicant, an interfolding machine is described that allows a quick change of only the folding rollers, or only the folding section, allowing an adjustment of the length of the sheets and of the panel length, and then the width of the packages of interfolded sheets, without adjusting other parts of the machine, and without the need of a time of adjustment of the machine.

By changing only the length of the sheets, or cut-off, it is possible to keep the same pack width, by adjusting the number of interfolded panels. It can be in particular preferable to adjust the cut-off without changing the pack width, leaving the user a variety of choices for making packs, in order to put different products in a same type of folded sheet dispenser. A common folding machine of “multifold” type allows to produce folded sheets of a single length and a single folding configuration of the panels, with an extremely stiff process, and for each sheet length a different machine is required.

In EP 1826165, in the name of the same applicant, an interfolding machine is described of multi-fold modular type, in which it is possible to cut a web of paper into sheets of different length after replacing a modular portion comprising the cutting roller and the transfer roller with another modular portion comprising a cutting roller and a transfer roller of different diameter, and then capable of cutting the web into sheets of different length and causing the sheets to be transferred to an overlapping section. This solution overcomes the limits of the multi-fold interfolding machines of traditional type, i.e. of cutting a web of paper into sheets and processing the sheets of a single length.

Owing to an increase of the variety of products required by the market, the companies need always more flexible machines, which in general are capable of folding sheets having a different number of folds, i.e. with a variable number of panels.

In particular, notwithstanding, on the one hand, interfolding machines exist that allow to adjust the panel length and then the pack width, and, on the other hand, interfolding machines that allow to adjust the length of the sheet, and then to make interfolded products with different number of panels, there are not machines that allow to provide in a flexible way both single-fold products, i.e. L-type interfolded sheets with two panels and one fold, and multi-fold products, for example Z-type interfolded sheets with three panels and two folds, or W-type interfolded sheets with four panels and three folds, or sheets with five or six panels.

In fact, the multi-fold machines, even if, as above said, can adjust the number of panels, as described in EP1826165, do not allow making L-type interfolded sheets, i.e. single-fold. Similarly, the single-fold machines are not suitable for making multi-fold products.

Moreover similar machines exist for making folded and stacked products that are not interfolded. Even in this case, they are stiff machines specifically designed for a certain product, concerning the number panels into which the panel Is folded and concerning the configuration of the fold.

### SUMMARY OF THE INVENTION

It is therefore a feature of the present invention to provide a structure of folding and stacking machine that provides folded stacks of sheets with sheets of different length in order to provide folding configurations with different size and/or number of panels, either interfolded or not interfolded.

It is still a feature of the present invention to provide a folding and stacking machine that can work obtaining stacks of interfolded sheets both with one fold only (single-fold), and with several folds (multi-fold).

It is still a feature of the present invention to provide a folding and stacking machine that can work obtaining interfolded stacks having different multiple folding configuration, for example 3,4,5,6 panels, and with different number of interfolded panels.

These and other features are accomplished by the folding and stacking machine, according to the present invention, to obtain packages of folded sheets starting from a web of paper, or similar material, comprising:
a folding section comprising a couple of folding rollers, said couple of folding rollers having a folding linear speed V_{P}, said folding rollers receiving a plurality of sheets and folding said sheets into a plurality of panels;
feeding means for feeding said sheets to said folding rollers, said feeding means comprising a first and a second sheet feeding line that are separate from each other,
whose characteristic is that:
said first sheet feeding line has a first sheet cutting section starting from a first web that works at a first feeding speed V₁, wherein said first feeding speed V₁ has a ratio X₁ with respect to the folding speed V_{P},
said second sheet feeding line has a second sheet cutting section starting from a second web that works at a second feeding speed V₂, wherein said second feeding speed V₂ has a ratio X₂ with respect to the folding speed V_{P},
means are provided for operating selectively and independently said first and said second sheet feeding lines.

In a preferred exemplary embodiment, said first cutting section of said first sheet feeding line comprises:
first cutting and transfer means adapted to cut a first web of paper into first sheets of length L₁ and to transfer them along a transfer path;
actuating means for actuating said cutting and transfer means so that said first web of paper and said first sheets proceed at said first speed V₁;
   and furthermore, said first sheet feeding line comprises:
overlapping means adapted to pick up said sheets from said transfer path and to overlap them in turn for a predetermined sheet portion, said portion being a fraction Y₁ of said length L₁;
actuating means for actuating said overlapping means adapted to convey said first sheets at said speed V_{P} less than said first speed V₁ towards said folding section, said speed difference being achieved for overlapping partially two consecutive sheets according to said portion;
and the cutting section of said second sheet feeding line comprises:
second cutting and transfer means adapted to cut the second web of paper into second sheets of length
L₂=L₁ and to transfer them along a transfer path towards said folding section;
actuating means for actuating said second cutting and transfer means adapted to cause them to work at a speed V₂ with said ratio X₂ equal to 1, whereby V₂=V_{P};
a microprocessor unit being provided adapted to control said actuating means between a first and a second condition, such that:
   in said first condition said actuating means for actuating said second line are kept still and said machine operates as multi-fold machine with sheets fed only through said first line;
   in said second condition said actuating means for actuating said second line are operated so that said ratio X₁ is equal to 1, whereby V₁=V_{P}, and so that said first sheets and said second sheets arrive already shifted in a confluence between said first and second line, so that said machine has single- fold type operation.

In another preferred exemplary embodiment, said first cutting section of said first sheet feeding line comprises:
first cutting and transfer means adapted to cut a first web of paper into first sheets of length L₁ and to transfer them along a transfer path;
actuating means for actuating said cutting and transfer means so that said first web of paper and said first sheets proceed at said first speed V₁;
   and furthermore, said first sheet feeding line comprises:
overlapping means adapted to pick up said sheets from said transfer path and to overlap them in turn for a predetermined sheet portion, said portion being a fraction Y₁ of said length L₁;
actuating means for actuating said overlapping means adapted to convey said first sheets at said speed V_{P} less than said first speed V₁ towards said folding section, said speed difference being achieved for overlapping partially two consecutive sheets according to said portion;
and the cutting section of said second sheet feeding line comprises:
second cutting and transfer means adapted to cut a first web of paper into first sheets of length L₂ and to transfer them along a transfer path;
actuating means for actuating said cutting and transfer means so that said first web of paper and said first sheets proceed at said first speed V₂;
   and furthermore, said first sheet feeding line comprises:
overlapping means adapted to pick up said sheets from said transfer path and to overlap them in turn for a predetermined sheet portion, said portion being a fraction Y₂ of said length L₂;
actuating means for actuating said overlapping means adapted to convey said first sheets at said speed V_{P} less than said first speed V₂ towards said folding section, said speed difference being achieved for overlapping partially two consecutive sheets according to said portion;
a microprocessor unit being provided adapted to control said actuating means between a first and a second condition, such that:
   in said first condition said actuating means for actuating said second line are kept still and said machine operates as multi-fold machine with sheets fed to said folding section only through said first line obtaining a first folded and stacked product with folded sheets having a number of panels P₁;
   in said second condition said actuating means for actuating said first line are kept still and said machine operates as multi-fold machine with sheets fed to said folding section only through said second line obtaining a second folded and stacked product with folded sheets having a number of panels P₂.
      Advantageously, in said first condition said first feeding speed V₁ has a ratio X₁ with respect to the folding speed V_{P} selected from the group comprised of:
   X₁=3/2, for Z-type folded sheets with two interfolded panels;
   X₁=4/2, for W-type folded sheets with two interfolded panels;
   X₁=5/4 for five panel folded sheets with one interfolded panel;
   X₁=6/3, for six panel folded sheets with three interfolded panels;
   X₁=6/4 for six panel folded sheets with two interfolded panels;
   whereas in said second condition said second feeding speed V2 has a ratio X₂ with respect to the folding speed V_{P} selected from the group comprised of:
   X₂=3/2, for Z-type folded sheets with two interfolded panels;
   X₂=4/2, for W-type folded sheets with two interfolded panels;
   X₂=5/4 for five panel folded sheets with one interfolded panel;
   X₂=6/3, for six panel folded sheets with three interfolded panels;
   X₂=6/4 for six panel folded sheets with two interfolded panels;
      being X₁ different from X₂.

In particular in said first condition said first feeding speed V₁ has a ratio X₁=3/₂ with respect to the folding speed V_{P} and in said second condition said second feeding speed V₂ has a ratio X₂=4/₂ with respect to the folding speed V_{P}, such that when operating the first or second sheet feeding line it is possible to have with a single machine Z-type interfolded sheets or W-type interfolded sheets.

In an exemplary embodiment of the invention, said folding and stacking machine has a folding section and two cutting sections, wherein a portion of said folding section is removable independently with respect to said cutting sections, said folding section comprising at least two folding rollers and being replaceable with an equivalent portion.

In particular said folding section comprises two modules having each a mobile folding roller.

In another exemplary embodiment of the invention, said folding and stacking machine has a folding section and two cutting sections, wherein a portion of said or each cutting section is removable independently with respect to the other cutting sections, said removable portion of said cutting section comprising at least one cutting roller and being replaceable with an equivalent portion.

Preferably, a portion of the first cutting section that is adapted to operate at a speed V₁ with sheets of length L1 is replaceable with an equivalent modular portion adapted to operate at a speed V₁′ with sheets of length L1′. Similarly, a portion of the first cutting section that is adapted to operate at a speed V₂ with sheets of length L₂ is replaceable with an equivalent modular portion adapted to operate at a speed V₂′ with sheets of length L₂′.

In a preferred exemplary embodiment, said folding and stacking machine has a folding section and two cutting sections, each cutting section and said folding section having a removable portion that can be removed independently in order to change the length of the sheet, the panel length, the folding configuration.

In a possible exemplary embodiment, for not interfolded folded products, said cutting sections are such that speeds V₁ or V₂ are lower than or equal to said speed V_{P}.

In particular said folding and stacking machine has a support frame of the cutting rollers, of the folding rollers, etc., and the removable portion of the folding section is removable independently from the frame of the machine, so that the folding rollers are removed as an unity, or as two mating sub-unities, and replaceable with an equivalent portion.

Alternatively, or in addition, the folding section has a left overlap roller and a left folding roller that are removable independently from said frame as a left modular portion, and a right overlap roller and a right folding roller that are removable independently from said frame as a right modular portion, said left and right modular portions being replaceable with equivalent portions, comprising any motion transmission means, all movable at said speed V_{P}, whereby for adjusting the diameter of said folding rollers it is possible to change said folding section and said overlap rollers.

In a further exemplary embodiment, the cutting section of said first sheet feeding line, and/or the cutting section of said second sheet feeding line comprise a portion having a modular structure that is removable integrally from said frame, for being replaced with an equivalent portion which is adapted to work with different cut-off.

### BRIEF DESCRIPTION OF THE DRAWINGS

Further characteristic and the advantages of the folding and stacking machine, according to the invention, will be made clearer with the following description of an exemplary embodiment thereof, exemplifying but not limitative, with reference to the attached drawings, in which like reference characters designed the same or similar parts, throughout the Figures of which:

FIG. 1 shows diagrammatically an elevational side view of a first exemplary embodiment of the folding and stacking machine, according to the invention, with operation in multi-fold mode;

FIG. 1A and 2A, 3A, 7A show a plurality of sheets that are overlapped according to a determined length for multi-fold or single-fold mode (FIG. 2A);

FIG. 2 shows the machine of FIG. 1 with operation in single-fold mode;

FIG. 3 shows diagrammatically an elevational side view of an exemplary embodiment of the folding and stacking machine of FIG. 1;

FIGS. 4 and 5 show in detail, respectively, a cutting roller and an overlap roller, mounted on the first sheet feeding line of the machine of FIG. 3, with overlapping length Y equal to one panel;

FIG. 6 shows diagrammatically a Z-type interfolded sheet configuration obtained by operating the first sheet feeding line of the machine of FIG. 3;

FIG. 7 shows diagrammatically an elevational side view of the folding and stacking machine of FIG. 2 where the first sheet feeding line is not operating and a second sheet feeding line is operating;

FIGS. 8 and 9 show in detail, respectively, a cutting roller and an overlap roller, mounted on the second sheet feeding line of the machine of FIG. 2;

FIG. 10 shows diagrammatically an interfolded configuration obtained by operating the second sheet feeding line of the machine of FIG. 3;

FIG. 11 shows another exemplary embodiment of a folding and stacking machine according to the invention, with modular interchangeability of the cutting sections and/or the folding sections of the sheets;

FIG. 12 shows an exemplary embodiment of the folding and stacking machine of FIG. 11,

FIG. 13 shows a product S-like folded sheets not interfolded, as an example of various folding configurations obtainable in preferred exemplary embodiments when interfolded sheets are not requested.

### DESCRIPTION OF A PREFERRED EXEMPLARY EMBODIMENT

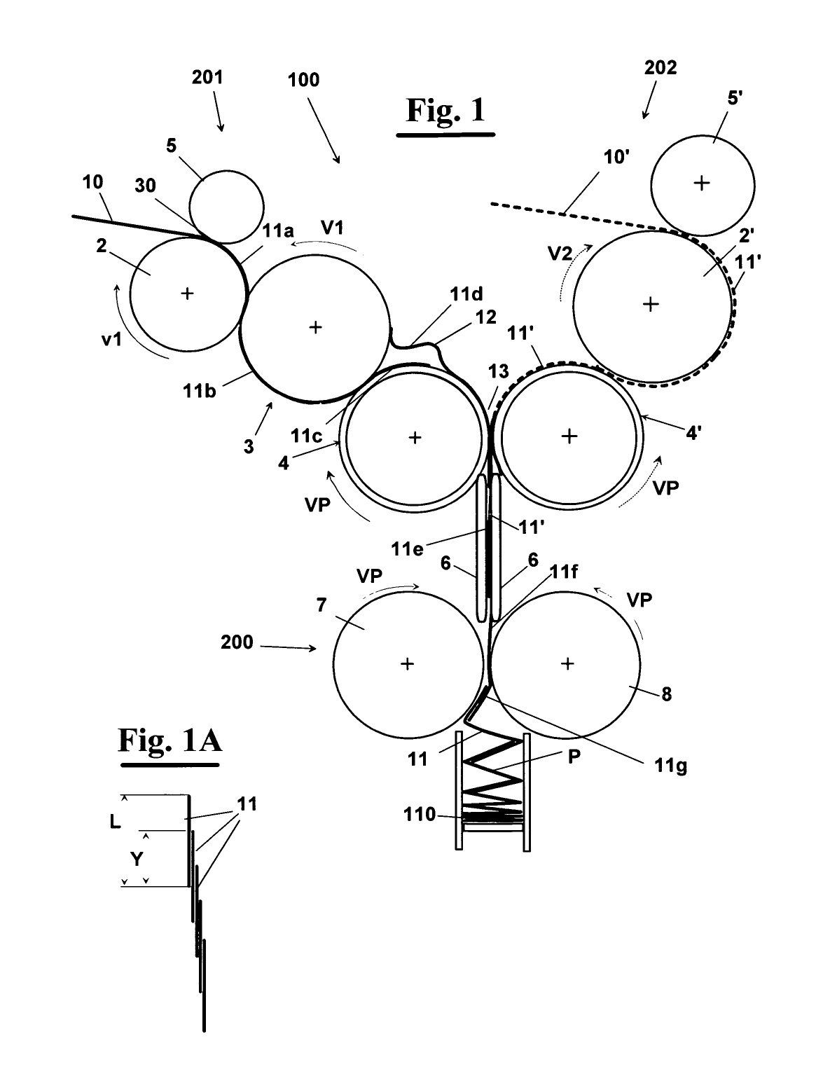

With reference to FIG. 1, a first exemplary embodiment of a folding and stacking machine 100 of a web of paper, or similar products, according to the invention, provides a first sheet feeding line 201 (to the left in the drawing) and a second sheet feeding line 202 (to the right in the drawing).

The machine 100 comprises, furthermore, a folding section 200 comprising a couple of folding rollers 7 and 8 having a linear folding speed V_{P}. Folding rollers 7 and 8 are adapted to receive a plurality of sheets 11 of length L overlapped for a fraction Y of their length L (see also FIG. 1A) and to fold them into a plurality of panels P.

In case a folding mode is selected such that that the fraction Y remains closed within the fold of the sheets, an interfolded product is obtained (for example FIG. 6 or FIG. 10). In case instead the folding mode is selected such that the overlapped fraction Y does not remain closed in the fold of the sheets, a folded but not interfolded product is obtained. Also in case of not overlapped sheets a folded but not interfolded product is obtained (for example FIG. 13).

The folding and stacking machine 100 comprises, furthermore, rollers 4 and 4′ and webs 6 of paper, adapted to be fed at a folding speed V_{P}, thus providing series of not yet folded cut sheets towards folding rollers 7 and 8. Rollers 4 and 4′ are located at a confluence point of the two lines 201 and 202 of feeding sheets.

Normally, according to the present invention, the first sheet feeding line 201 provides a first sheet cutting section starting from a first web 10 that works at a speed V₁, where V₁ has a ratio X₁ with respect to the folding speed V. Similarly, second sheet feeding line 202 provides a second sheet cutting section starting from a second web 10′ that works at a cutting speed V₂, where V₂ has a ratio X₂ with respect to folding speed V_{P}.

Furthermore, the first and the second sheet feeding lines 201 and 202 can be operated selectively and independently, i.e. either separately from each other or at the same time, according to the desired type of interfolded configuration. In the present exemplary embodiment the two lines are made and are operated in the way described below.

In a first mode of operation, so-called multi-fold, shown in FIG. 1, only the first sheet feeding line 201 is operated, whereas second sheet feeding line 202 remains still. The web 10′ and the sheets 11′ of the line are indicated with a dashed line, but actually they are missing in this mode of operation.

The first sheet feeding line 201 comprises a cutting roller 2 that operates the division of web 10 into sheets 11 of a determined length. The cut sheets, having all a same length, which are conveyed through the machine, are indicated as 11a, 11b, 11c, 11d, 11e, 11f and 11g, starting from the cutting point arranged at counter-cutting element 30 of a fixed counter-cutting roller 5, up to the point where they are interfolded. In an exemplary embodiment shown in FIG. 1, downstream of cutting roller 2 a transfer roller 3 is provided that conveys sheets 11 to an overlapping means, for example an overlapping roller, also-called “overlap” roller, which is the same roller 4 already above cited. Up to transfer roller 3, sheets 11 travel along a transfer path at a speed V₁, whereas starting from the overlap roller 4, sheets 11 are brought at a second speed V_{P}, with V_{P} that is less than said first speed V₁. This speed difference causes sheets 11c and 11d to overlap, since sheet 11c, having speed V₁, is put below sheet 11d downstream of it having speed V_{P} less than first speed V₁. The overlapping slip between the two sheets 11c and 11d is carried out for a fraction Y, visible in FIG. 1A, corresponding to a predetermined number of panels, in order to allow eventually a number of interfolded panels, at folding rollers 7 and 8, adapted to form a stack 110.

The speed difference V₁−V_{P} determines the length of the overlapped fraction Y (FIG. 1A), which can be selectively equal to one, two, three or even more panels, for example one panel in FIG. 6 or two panels in FIG. 10. This speed difference causes also the production of a U-bend 12, immediately starting from the zone following the head of sheet 11d.

By operating only sheet feeding line 201, it is possible to obtain an interfolded configuration, for example “W”- “Z”-like configuration, in a way similar to what can be obtained with traditional multi-fold type machines. Alternatively, it is possible to obtain a variety of interfolded configurations, like those described in European patent application EP08156875.0 in the name of the same applicant, or in EP1826165.

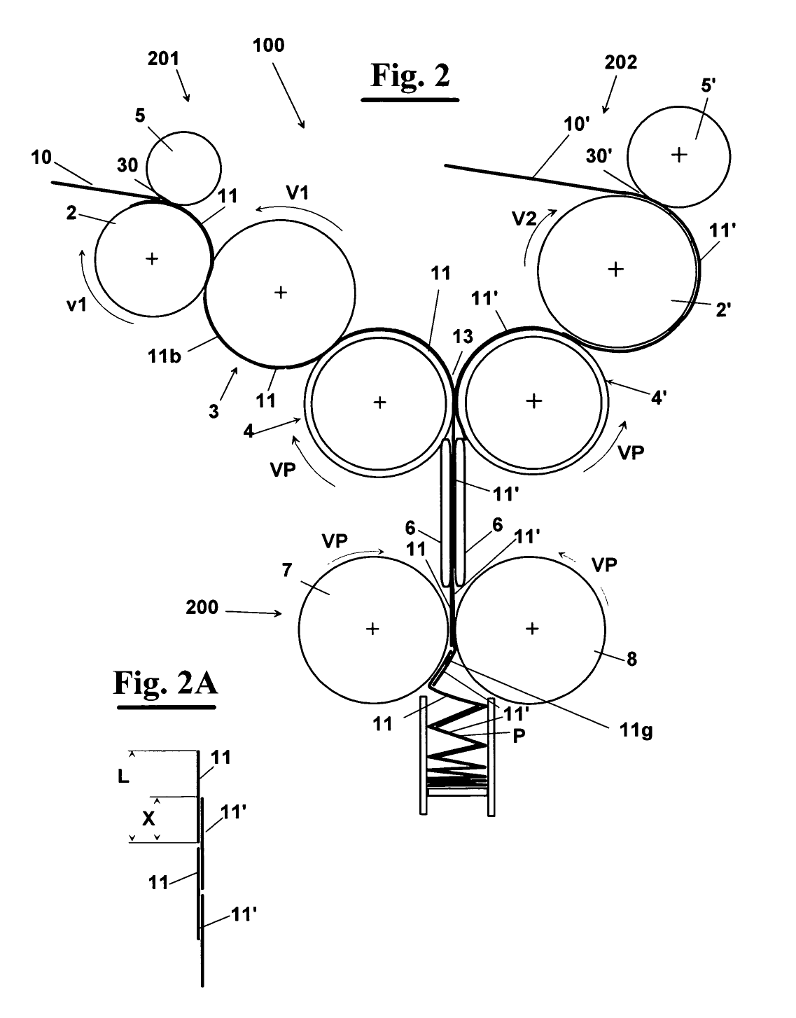

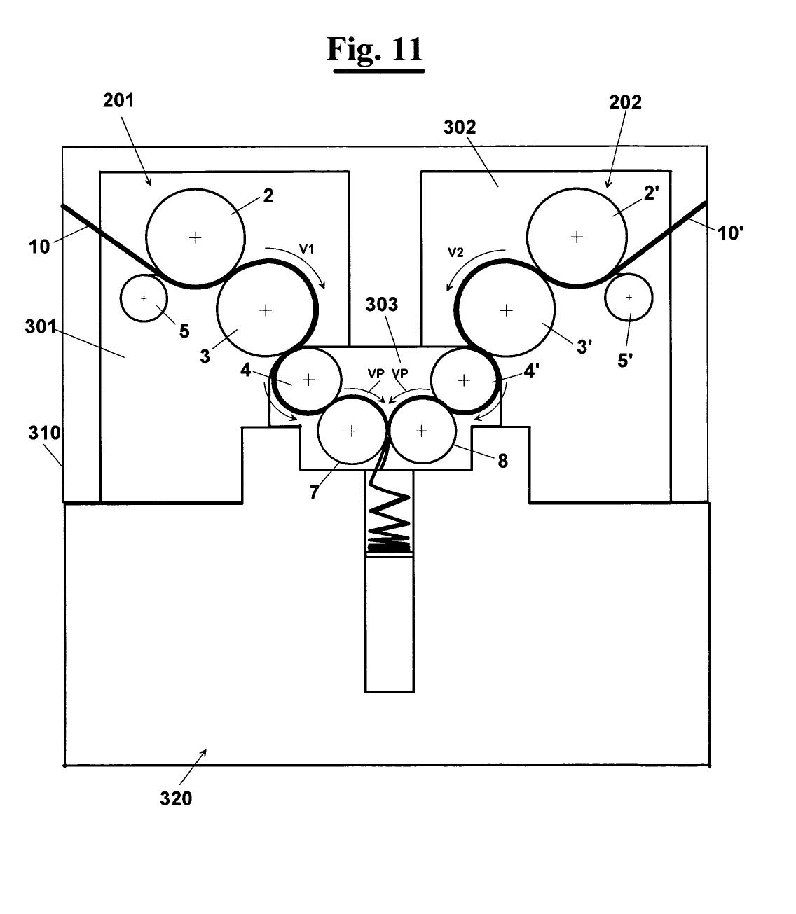

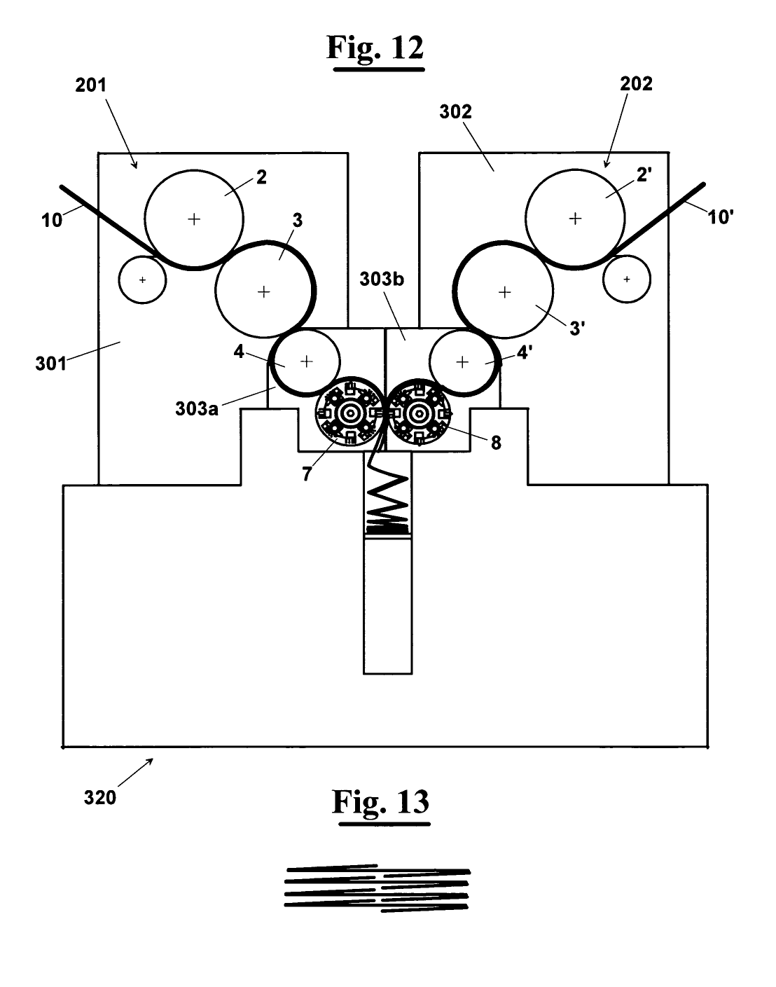

In FIGS. 1 and 2, webs 6 of paper are shown that bring the sheets overlapped from the confluence of rollers 4 and 4′ to folding rollers 7 and 8. Obviously, rollers 4 and 4′ can be directly adjacent to rollers 7 and 8, as shown in FIG. 11 or 12. Similarly, rollers 4 and 4′, with obvious changes to the path of the paper, can be missing, and folding rollers 7 and 8 can work as overlap rollers, directly, with rollers 2 and 3 that travel at speed V₁ or V₂, and folding rollers 7 and 8 that travel at speed V_{P}.

Similarly, rollers 3, 3′ can be missing, and cutting rollers can directly transfer the sheets either onto overlap rollers 4, or 4′, or directly onto folding rollers 7 and 8.

In a second mode of operation, so-called single-fold mode, shown in FIG. 2, both first sheet feeding line 201 and second sheet feeding line 202 are operated, to obtain interfolded single-fold type configurations for example of “L”-type.

Sheet feeding line 201, in this case, is modified so that overlap roller 4, folding rollers 7 and 8 and transfer roller 3 and cutting roller 2 of line 201 rotate at a same linear speed V₁=V_{P} and the ratio X₁ is equal to 1. In the meantime, line 202 is operated, where V₂=V_{P}, by feeding sheets so that they overlap with those coming from line 201 in the way indicated in FIG. 2A.

Second sheet feeding line 202 comprises a cutting roller 2′ that operates the division of web 10′ into sheets 11′ of determined length. The cut sheets 11′, having all a same length, are carried along the machine starting from the cutting point arranged at counter-cutting element 30′ of a fixed counter-cutting roller 5′, up to the point where they are overlapped with sheets 11 coming from line 201 in the way indicated by FIG. 2A. In the exemplary embodiment shown in FIG. 2, downstream of cutting roller 2′, the above cited roller 4′ is provided that brings sheets 11′ to the confluence with sheets 11 at roller 4.

Then, roller 4 of line 201, where V₁=V_{P}, acts as simple conveying roller for sheets 11, that are partially overlapped to sheets 11′ coming from line 202 and folded at folding rollers 7 and 8, thus obtaining a desired single-fold configuration.

It should be noted that the length L, or cut-off, of the sheets of lines 201 and 202 is the same. In order to change the width of panels P it is necessary to proceed as described hereinafter. It must be noted that the speed V₂ could also be less than first speed V_{P} if the overlapping length between sheets 11 and 11′ is less than 50%.

An exemplary embodiment of the folding and stacking machine 100 shown in FIGS. from 3 to 9 provides a first sheet feeding line 201 and a second sheet feeding line 202 similar to line 201 of FIG. 1, operated in order to work only one at a time alternatively, i.e. one or the other, and not at the same time.

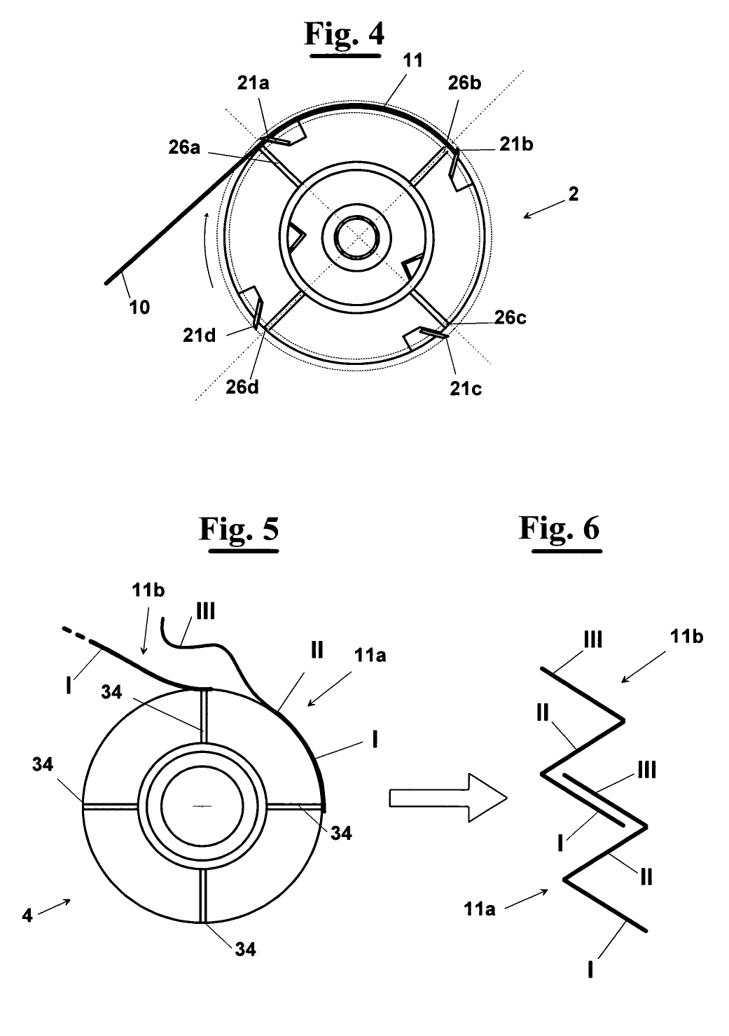

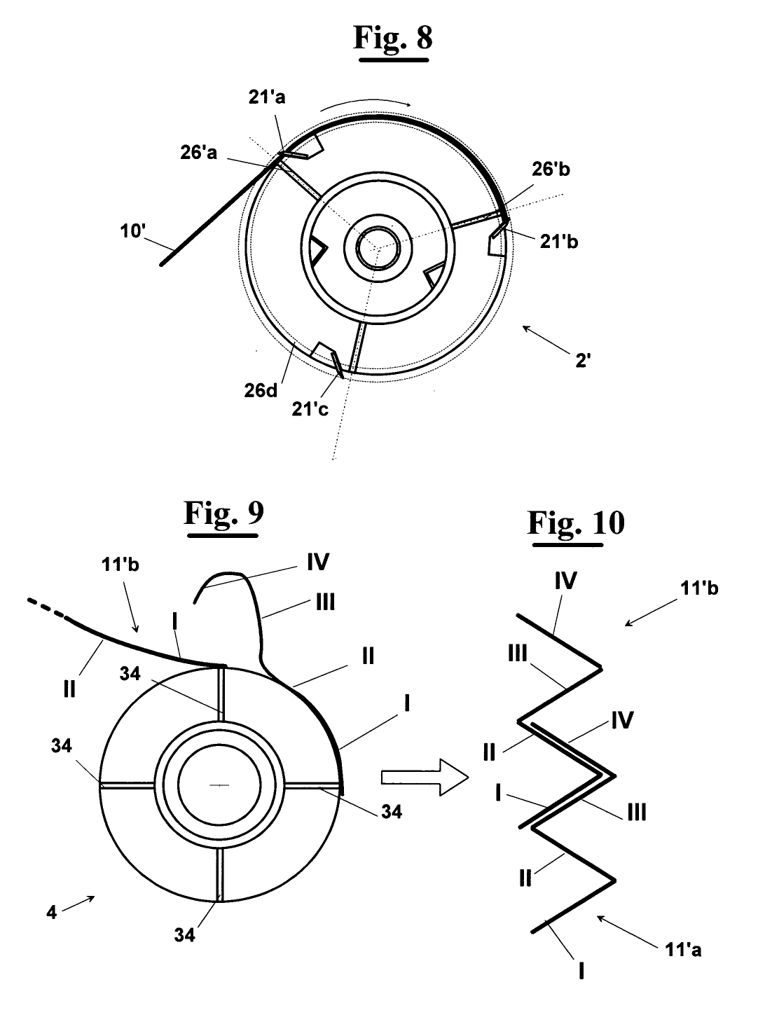

In this case, the first sheet feeding line 201 comprises a cutting roller 2 having four knives arranged at 90° (FIG. 4) whereas second sheet feeding line 202 comprises a cutting roller 2′ having three knives arranged at 120° (FIG. 8), adapted to operate at the respective counter-cutting elements 30 and 30′ of fixed counter-cutting rollers 5 and 5′. In particular first and second sheet feeding line 201 and 202 are operated alternatively, to provide respectively a Z-type interfolding configuration, and a W-type interfolding configuration, as described in detail hereafter.

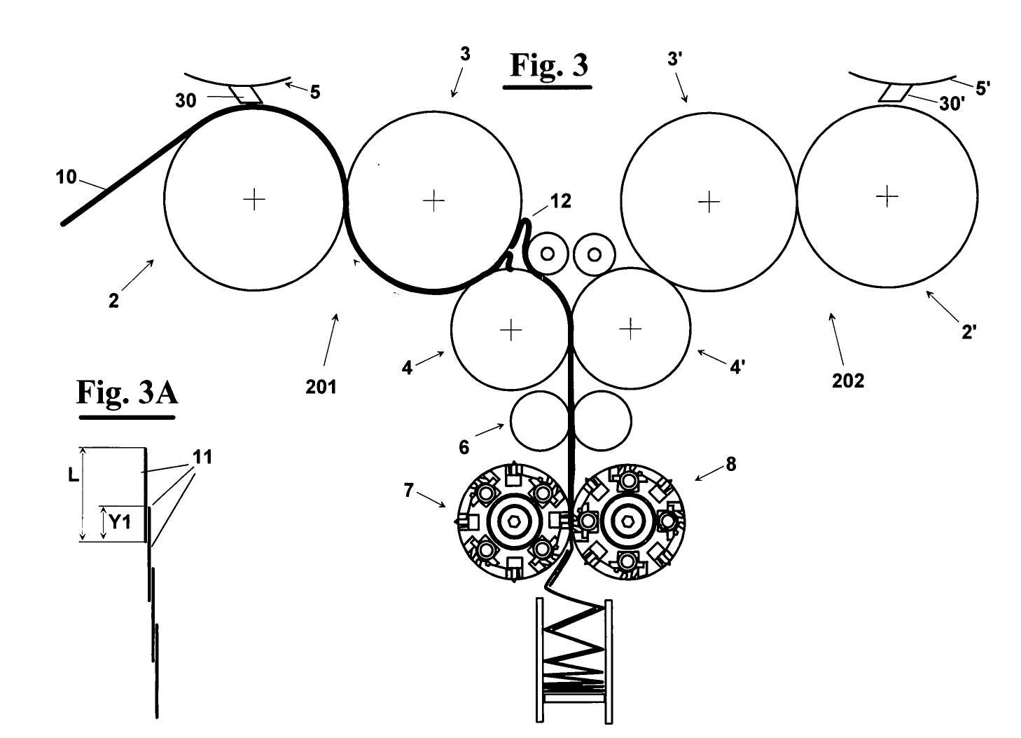

In particular when the first sheet feeding line 201 (FIG. 3) is operated, cutting roller 2 causes the division of the web of paper 10 into sheets 11 having a same length as a fourth of the circumference of cutting roller 2 (FIG. 4). In this case, each sheet 11, at speed V₁=2/3V_{P}, is fed in a overlapped way by length Y₁ (FIG. 3A) and then folded by folding rollers 7 and 8 with three panels I-III, and a Z-type interfolded configuration is obtained with the last panel III of next sheet 11a overlapped to first panel III of previous sheet 11b (FIGS. 5 and 6).

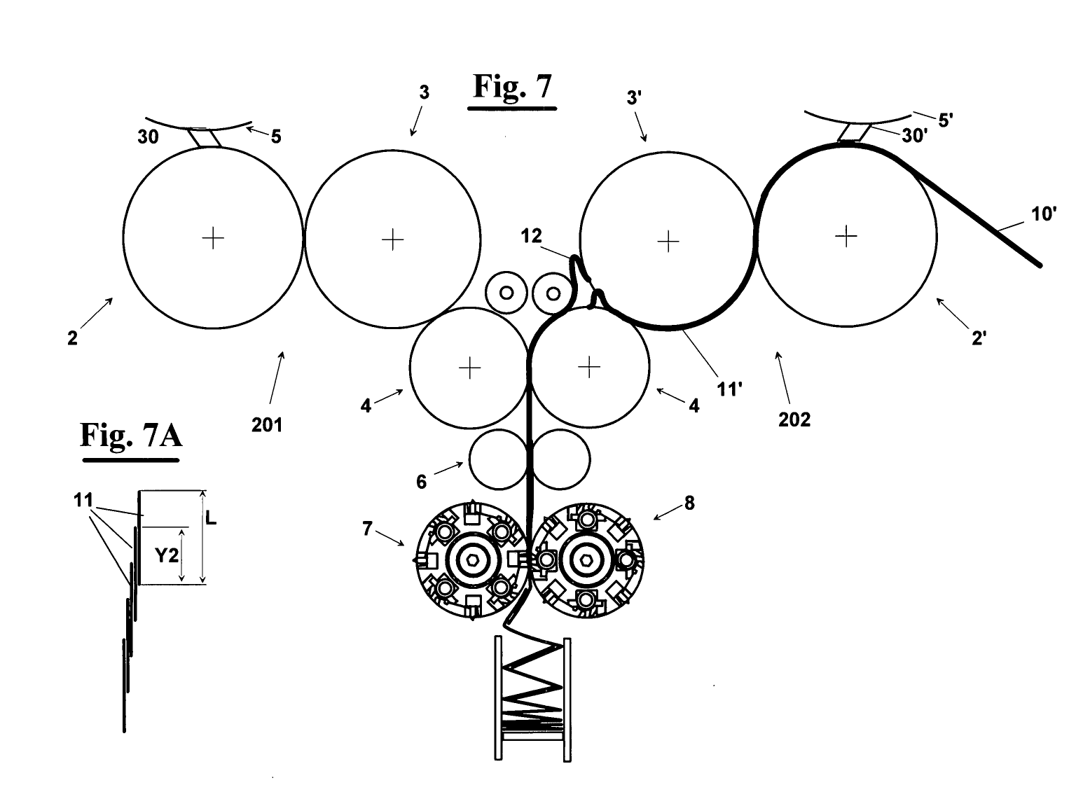

When, instead, sheet feeding line 202 is operated, cutting knives 21′a-21′c of roller 2′ cut the web of paper 10′ into sheets 11′ that have a length equal to one third of the circumference of cutting roller 2′ (FIG. 8). In this case, each sheet 11′, at the speed V₂=2V_{P}, is fed in a way overlapped and shifted according to length Y₂ (FIG. 7A) and is then folded by rollers 7 and 8 into four panels I-IV and an interfolded configuration of “W”-type is obtained with the last two panels III and IV of next sheet 11′a overlapped to the panels III and IV of previous sheet 11′b upstream from (FIGS. 9 and 10).

Then, in the mode of FIG. 3 the ratio X₁ between V₁ and V_{P} is 3/2, whereas in the mode of FIG. 7 the ratio X₂ between V₂ and V_{P} is 4/2. Obviously, other ratios can be used between the speeds, with X=5/4 for five panel folded sheets with one interfolded panel; X=6/3, for six panel folded sheets with three interfolded panels; X=6/4 for six panel folded sheets with two interfolded panels, as well as other combinations are possible. In case the machines are made in a stiff way, i.e.

with ratios X₁ and X₂ fixed for lines 201 and 202, two possible configurations of product can be obtained by the machine. This is already a high advantage with respect to the existing stiff machines that can make a single product.

Moreover, in the way described hereinafter, or in the way described in EP08156875.0 or in EP1826165, and EP1630118 in the name of the same applicant, many other configurations can be obtained and the solution according to the invention doubles the number of products that can be obtained with an existing folding and stacking machine.

In the exemplary embodiment shown in FIG. 11 the machine 100 provides a modular structure comprising a plurality of removable portions, for example three removable portions 301, 302 and 303. In a first removable portion 301 all the unit for rollers and transmission that works at the linear speed V1 can be replaced, and, in particular, the cutting roller 2 and transfer roller 3. Similarly, in the second removable portion 302 all the unit for rollers and transmission that works at the linear speed V₂ can be replaced and, in particular, the cutting rollers 2′ and of transfer 3′.

This way, changing the ratio X₁ or X₂, the number of overlapped panels is changed, or a not interfolded product is obtained. In addition to the ratios between the speeds there is also the possibility of adjusting the cutoff, i.e. the length of the sheets.

Instead, in third releasable portion 303, overlap rollers 4 and 4′ and folding rollers 7 and 8 are mounted on a removable portion 303, that is movable independently from the others. This way it is possible to adjust the length of the sheet.

This exemplary embodiment allows changing quickly the type of product, providing either a multi-fold machine on both lines 201 and 202, according to FIGS. 3 and 7, with different multi-fold products on the right and left sides, or a multi-fold/single-fold machine according to FIGS. 1 and 2. This can be obtained for example by a contemporaneous change of the three modules or removable portions 301, 302 and 303, to obtain a desired type of product, either interfolded or not, with a single machine.

Normally, in a way similar to that above described with reference to FIGS. from 3 to 9, the machine can be capable of working selectively either as a multi-fold machine, for example for making “Z”-type folded sheets and “W”-type folded sheets, or as a single-fold machine.

In the latter case it is possible operating at the same time line 201 and line 202 after having replaced one of the removable portions, for example portion 302, with an equivalent portion 302, but equipped with a cutting roller 2′ having a number of knives identical to portion 301 and suitable for dividing webs 10 and 10′ into sheets 11 of length substantially equal to twice (or four times, in case of single-fold with double fold of each panel) of the length of the panels that are obtained using determined folding rollers 7 and 8. In this case, furthermore, the overlap rollers 4 and 4′, the cutting rollers 2 and 2′ and the transfer rollers 3 and 3′ are caused to rotate so that the respective linear speed are equal. This way, as described above with reference to FIG. 1A, overlap rollers 4 and 4′ work as simple sheet conveying rollers 11, and an L-type interfolded configuration, i.e. of single-fold type, is obtained at folding rollers 7 and 8.

It is also possible to replace the removable portion 303 with another portion 303 equipped with folding rollers 7 and 8 adapted to provide panels P of desired length Lp.

Alternatively, it is possible to use folding rollers 7 and 8 adapted to a variable length of sheet in a limited number of combinations, i.e. capable of adapting the length/number of the panels to the length of the sheet.

In FIG. 12, finally, an exemplary embodiment is shown of the modular structure of the folding and stacking machine of FIG. 11. In this case two modular independent portions 303a and 303b are provided each of which comprises a folding roller 7, or 8, and an overlap roller 4, or 4′, respectively. This solution, in particular, allows a quicker and easier replacement of the portion 303a, or 303b, with an other equivalent portion.

Notwithstanding in the different exemplary embodiments of the folding and stacking machine 100 above described with reference to FIGS. from 1 to 12, the folding speed V_{P} is equal to, or less than, the feeding speed V₁ of web of paper 10, or 10′, the extent of the present invention covers also further exemplary embodiments, not shown, for which V_{P} is higher than V₁. In this case stacks of sheets are produced that are simply folded and not interfolded, as shown in FIG. 13.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Folding and stacking machine to obtain packages of folded sheets starting from a web of paper, or similar material, comprising:
a folding section comprising a couple of folding rollers, said couple of folding rollers having a folding linear speed V_{P}, said folding rollers receiving a plurality of sheets and folding said sheets into a plurality of panels;
feeding means for feeding said sheets to said folding rollers, said feeding means comprising a first and a second sheet feeding line that are separate from each other, characterised in that:
said first sheet feeding line has a first sheet cutting section starting from a first web that works at a first feeding speed V₁, wherein said first feeding speed V₁ has a ratio X₁ with respect to the folding speed V_{P},
said second sheet feeding line has a second sheet cutting section starting from a second web that works at a second feeding speed V₂, wherein said second feeding speed V₂ has a ratio X₂ with respect to the folding speed V_{P},
means are provided for operating selectively and independently said first and said second sheet feeding lines.

2. Machine according to claim 1, wherein said first cutting section of said first sheet feeding line comprises:
first cutting and transfer means adapted to cut a first web of paper into first sheets of length L₁ and to transfer them along a transfer path;
actuating means for actuating said cutting and transfer means so that said first web of paper and said first sheets proceed at said first speed V₁;
and furthermore, said first sheet feeding line comprises:
overlapping means adapted to pick up said sheets from said transfer path and to overlap them in turn for a predetermined sheet portion, said portion being a fraction Y₁ of said length L₁;
actuating means for actuating said overlapping means adapted to convey said first sheets at said speed V_{P} less than said first speed V₁ towards said folding section, said speed difference being achieved for overlapping partially two consecutive sheets according to said portion;
and the cutting section of said second sheet feeding line comprises:
second cutting and transfer means adapted to cut the second web of paper into second sheets of length L₂=L₁ and to transfer them along a transfer path towards said folding section;
actuating means for actuating said second cutting and transfer means adapted to cause them to work at a speed V2 with said ratio X₂ equal to 1, whereby V₂=V_{P};
a microprocessor unit being provided adapted to control said actuating means between a first and a second condition, such that:
in said first condition said actuating means for actuating said second line are kept still and said machine operates as multi-fold machine with sheets fed only through said first line;
in said second condition said actuating means for actuating said second line are operated so that said ratio X₁ is equal to 1, whereby V₁=V_{P} and so that said first sheets and said second sheets arrive already shifted in a confluence between said first and second line, so that said machine has single-fold type operation.

3. Machine according to claim 1, wherein said first cutting section of said first sheet feeding line comprises:
first cutting and transfer means adapted to cut a first web of paper into first sheets of length L₁ and to transfer them along a transfer path;
actuating means for actuating said cutting and transfer means so that said first web of paper and said first sheets proceed at said first speed V₁;
and furthermore, said first sheet feeding line comprises:
overlapping means adapted to pick up said sheets from said transfer path and to overlap them in turn for a predetermined sheet portion, said portion being a fraction Y₁ of said length L₁;
actuating means for actuating said overlapping means adapted to convey said first sheets at said speed V_{P} less than said first speed V₁ towards said folding section, said speed difference being achieved for overlapping partially two consecutive sheets according to said portion;
and the cutting section of said second sheet feeding line comprises:
second cutting and transfer means adapted to cut a first web of paper into first sheets of length L₂ and to transfer them along a transfer path;
actuating means for actuating said cutting and transfer means so that said first web of paper and said first sheets proceed at said first speed V₂;
and furthermore, said second sheet feeding line comprises:
overlapping means adapted to pick up said sheets from said transfer path and to overlap them in turn for a predetermined sheet portion, said portion being a fraction Y₂ of said length L₂;
actuating means for actuating said overlapping means adapted to convey said first sheets at said speed V_{P} less than said first speed V₂ towards said folding section, said speed difference being achieved for overlapping partially two consecutive sheets according to said portion;
a microprocessor unit being provided adapted to control said actuating means between a first and a second condition, such that:
in said first condition said actuating means for actuating said second line are kept still and said machine operates as multi-fold machine with sheets fed to said folding section only through said first line obtaining a first folded and stacked product with folded sheets having a number of panels P₁;
in said second condition said actuating means for actuating said first line are kept still and said machine operates as multi-fold machine with sheets fed to said folding section only through said second line obtaining a second folded and stacked product with folded sheets having a number of panels P₂.

4. Machine according to claim 1, where in said first condition said first feeding speed V₁ has a ratio X₁ with respect to the folding speed VP selected from the group comprised of:
X₁=3/2, for Z-type folded sheets with two interfolded panels;
X₁=4/2, for W-type folded sheets with two interfolded panels;
X₁=5/4 for five panel folded sheets with one interfolded panel;
X₁=6/3, for six panel folded sheets with three interfolded panels;
X₁=6/4 for six panel folded sheets with two interfolded panels;
whereas in said second condition said second feeding speed V2 has a ratio X₂ with respect to the folding speed VP selected from the group comprised of:
X₂=3/2, for Z-type folded sheets with two interfolded panels;
X₂=4/2, for W-type folded sheets with two interfolded panels;
X₂=5/4 for five panel folded sheets with one interfolded panel;
X₂=6/3, for six panel folded sheets with three interfolded panels;
X₂=6/4 for six panel folded sheets with two interfolded panels;
being X₁ different from X₂.

5. Machine according to claim 4, where in said first condition said first feeding speed V₁ has a ratio X₁=3/2 with respect to the folding speed V_{P} and in said second condition said second feeding speed V₂ has a ratio X₂=4/2 with respect to the folding speed V_{P}, such that when operating the first or second sheet feeding line it is possible to have with a single machine Z-type interfolded sheets or W-type interfolded sheets.

6. Machine according to claim 1, wherein said folding and stacking machine has a folding section and two cutting sections, wherein a portion of said folding section is removable independently with respect to said cutting sections, said folding section comprising at least two folding rollers and being replaceable with an equivalent portion.

7. Machine according to claim 6, wherein said folding section comprises two modules having each a mobile folding roller.

8. Machine according to claim 1, wherein said folding and stacking machine has a folding section and two cutting sections, wherein a portion of said or each cutting section is removable independently with respect to the other cutting sections, said removable portion of said cutting section comprising at least one cutting roller and being replaceable with an equivalent portion.

9. Machine according to claim 8, wherein a portion of the first cutting section that is adapted to operate at a speed V₁ with sheets of length L₁ is replaceable with an equivalent modular portion adapted to operate at a speed V₁′ with sheets of length L₁′.

10. Machine according to claim 8, wherein a portion of the first cutting section that is adapted to operate at a speed V₂ with sheets of length L₂ is replaceable with an equivalent modular portion adapted to operate at a speed V₂′ with sheets of length L₂′.

11. Machine according to claim 6, wherein said folding and stacking machine has a folding section and two cutting sections, each cutting section and said folding section having a removable portion that can be removed independently in order to change the length of the sheet, the panel length, the folding configuration.

12. Machine according to claim 1, wherein for not interfolded folded products, said cutting sections are such that said speed V₁ or V₂ are identical or less than said speed V_{P}.
